(19) United States
(12) Patent Application Publication
(10) Pub. No.: US 2020/0074867 A1
(43) Pub. Date: Mar. 5, 2020

(54) METHOD AND SYSTEM FOR GENERATING AND FOLLOWING AN OPTIMIZED FLIGHT TRAJECTORY OF AN AIRCRAFT

(71) Applicant: Airbus Operations (S.A.S.), Toulouse (FR)

(72) Inventors: Thibault Lefez, Saiguede (FR); Jean-Claude Mere, VERFEIL (FR); Sylvain Raynaud, Cornebarrieu (FR)

(21) Appl. No.: 16/559,898

(22) Filed: Sep. 4, 2019

(30) Foreign Application Priority Data
Sep. 5, 2018 (FR) 1857964

(51) Int. Cl. G08G 5/00

(52) U.S. Cl. CPC G08G 5/0039; G08G 5/0091

(57) ABSTRACT

A method and system for generating an optimized flight trajectory of an aircraft. The generation system includes a module for determining a long-term flight trajectory from an obstacle prediction model, a following module for the aircraft to fly by following the long-term flight trajectory and a module for updating the long term trajectory from a short-term trajectory as a function of characteristics of at least one obstacle detected during the following of the long-term flight trajectory by the aircraft and as a function of a predetermined risk criterion threshold. The generation system makes it possible to generate a flight trajectory that avoids obstacles simply and reliably.

### CROSS-REFERENCE TO RELATED APPLICATION

This application claims priority to French patent application 18 57964 filed on Sep. 5, 2018, the entire disclosure of which is incorporated by reference herein.

### TECHNICAL FIELD

The disclosure herein relates to a method and a system for generating and following an optimized flight trajectory of an aircraft.

### BACKGROUND

An object of the disclosure herein is to generate an optimized flight trajectory of an aircraft, in particular of a transport aeroplane, of an unmanned aircraft or a drone, which is capable of flying in constrained dynamic environments, that is to say in environments which are likely to contain objects or obstacles, with which the aircraft must avoid coming into collision, but that the aircraft may be required to cross in certain conditions. These objects or these obstacles correspond in particular to moving objects such as areas of meteorological disturbances, such as storms. Generally, the flight trajectories are constructed without taking the environment into account. These are superimposed on a representation of the environment on the control screens of the aircraft for the pilot to be able to identify any conflicts with an obstacle or obstacles and take appropriate corrective actions depending on the obstacle or obstacles.

In the case of an unmanned aircraft, the performance of functions that make it possible to perform an unmanned flight (without the intervention of a pilot) while guaranteeing flight safety with respect to obstacles is difficult. Indeed, it involves a great degree of complexity both in terms of quantity of data to be manipulated and in terms of complexity of logic operations to be performed.

### SUMMARY

An object of the disclosure herein is to mitigate these drawbacks by proposing a method and a system allowing the avoidance of obstacles simply and reliably.

To this end, the disclosure herein relates to a method for generating and following an optimized flight trajectory of an aircraft.

According to the disclosure herein, the generation and following method comprises the following steps, implemented iteratively:
a first determination step, implemented by a determination module, comprising or consisting in determining a long-term flight trajectory from an obstacle prediction model;
a first following step, implemented by a following module, comprising or consisting in the aircraft flying by following the long-term flight trajectory;
an update step, implemented iteratively by an update module, comprising or consisting in updating the long-term trajectory from a short-term trajectory, the short-term trajectory being determined as a function of characteristics of at least one obstacle detected during the following of the long-term flight trajectory by the aircraft and as a function of a predetermined risk criterion threshold, the short-term flight trajectory being determined to avoid the detected obstacle likely to be encountered by the long-term flight trajectory.

Thus, by virtue of the update step, the flight trajectory determined from an obstacle prediction model can be modified to take account of obstacles not predicted and detected during the flight of the aircraft.

Furthermore, the update step comprises the following substeps:
a detection substep, implemented by a detection submodule, comprising or consisting in detecting at least one characteristic of at least one obstacle likely to be encountered by the long-term flight trajectory followed by the aircraft;
a first computation substep, implemented by a first computation submodule, comprising or consisting in computing a criterion of risk of the obstacle or obstacles from the characteristic or characteristics detected in the detection substep;
a first risk evaluation substep, implemented by a first risk evaluation submodule, comprising or consisting in comparing the risk criterion with the predetermined risk criterion threshold, if the risk criterion is below the predetermined risk criterion threshold, the update step comprising:
a first following substep, implemented by a first following submodule, comprising or consisting in the aircraft continuing to fly by following the long-term flight trajectory;
if the risk criterion is above or equal to the predetermined risk criterion threshold, the update step comprising:
a first determination substep, implemented by a first determination submodule, comprising or consisting in determining the short-term flight trajectory from the characteristic or characteristics detected in the detection substep;
a second following substep, implemented by a second following submodule, comprising or consisting in the aircraft flying by following the short-term flight trajectory;
a second determination substep, implemented by a second determination submodule, comprising or consisting in determining a new long-term flight trajectory from a state of the aircraft corresponding to a final state of the short-term flight trajectory, from the obstacle prediction model and from an evaluation of risks of encountering obstacles.

According to a particular feature, the first determination substep comprises determining the short-term flight trajectory from the obstacle prediction model modified by the characteristic or characteristics detected in the detection substep.

Furthermore, the first determination substep comprises determining the short-term flight trajectory from, in addition, a distance between the aircraft and a terrain flown over by the aircraft.

Moreover, the second determination substep comprises the following substeps, implemented iteratively:
a second computation substep, implemented by a second computation submodule, comprising or consisting in computing an auxiliary long-term flight trajectory from the final state of the short-term trajectory and from the obstacle prediction model;
a second risk evaluation substep, implemented by a second risk evaluation submodule, comprising or consisting in evaluating the risk of an obstacle being encountered by the auxiliary long-term flight trajectory;
if the computed auxiliary long-term flight trajectory is likely to pass through an area with risk, the second determination substep resumes at the second computation substep, otherwise, the new long-term flight trajectory corresponds to the auxiliary long-term flight trajectory.

Furthermore, if all the computed long-term flight trajectories are likely to pass through an area with risk, the flight trajectory followed by the aircraft corresponds to a flight trajectory with minimum risk.

According to a particular feature, the long-term flight trajectory is determined in the first determination step, in addition, from meteorological data transmitted to the determination module from a device on the ground.

The disclosure herein relates also to a system for generating and following an optimized flight trajectory of an aircraft.

According to the disclosure herein, the generation and following system comprises the following modules implemented iteratively:
a determination module, configured to determine a long-term flight trajectory from an obstacle prediction model;
a following module, configured for the aircraft to fly by following the long-term flight trajectory;
an update module, implemented iteratively, configured to update the long-term trajectory from a short-term trajectory, the short-term trajectory being determined as a function of characteristics of at least one obstacle detected during the following of the long-term flight trajectory by the aircraft and as a function of a predetermined risk criterion threshold, the short-term flight trajectory being determined to avoid the detected obstacle likely to be encountered by the long-term flight trajectory.

Furthermore, the update module comprises:
a detection submodule configured to detect at least one characteristic of an obstacle likely to be encountered by the long-term flight trajectory followed by the aircraft;
a first computation submodule configured to compute a criterion of risk of the obstacle or obstacles from the characteristic or characteristics detected by the detection submodule;
a first risk evaluation submodule configured to compare the risk criterion with the predetermined risk criterion threshold, if the risk criterion is below the predetermined risk criterion threshold, the update module being configured to implement:
a first following submodule configured for the aircraft to continue to fly by following the long-term flight trajectory;
if the risk criterion is above or equal to the predetermined risk criterion threshold, the update module being configured to implement:
a first determination submodule configured to determine the short-term flight trajectory from the characteristic or characteristics detected by the detection submodule;
a second following submodule configured for the aircraft to fly by following the short-term flight trajectory;
a second determination submodule configured to determine a new long-term flight trajectory from a state of the aircraft corresponding to a final state of the short-term flight trajectory, from the obstacle prediction model and from an evaluation of risks of encountering obstacles.

According to a particular feature, the first determination submodule is configured to determine the short-term flight trajectory from the obstacle prediction model modified by the characteristic or characteristics detected by the detection submodule.

Furthermore, the first determination submodule is configured to determine the short-term flight trajectory from, in addition, a distance between the aircraft and a terrain flown over by the aircraft.

Moreover, the second determination submodule comprises the following submodules, implemented iteratively:
a second computation submodule configured to compute an auxiliary long-term flight trajectory from the final state of the short-term trajectory and from the obstacle prediction model;
a second risk evaluation submodule configured to evaluate the risk of an obstacle being encountered by the auxiliary long-term flight trajectory; if the computed auxiliary long-term flight trajectory is likely to pass through an area with risk, the second determination submodule reiterates the implementation of the second computation submodule,

otherwise, the new long-term flight trajectory corresponds to the auxiliary long-term flight trajectory.

According to a particular feature, if all the computed long-term flight trajectories are likely to pass through an area with risk, the flight trajectory followed by the aircraft corresponds to a flight trajectory with minimum risk.

The disclosure herein relates also to an aircraft, in particular a transport aeroplane or an unmanned aeroplane, which comprises a system for generating and following an optimized flight trajectory of an aircraft, as specified above.

### BRIEF DESCRIPTION OF THE DRAWINGS

The disclosure herein, with its features and advantages, will emerge more clearly on reading the description given with reference to the attached, example drawings in which:

FIG. 1 represents an embodiment of the system for generating and following an optimized flight trajectory,

FIG. 2 represents an aircraft with the generation and following system embedded,

FIG. 3 represents an embodiment of the generation and following method.

### DETAILED DESCRIPTION

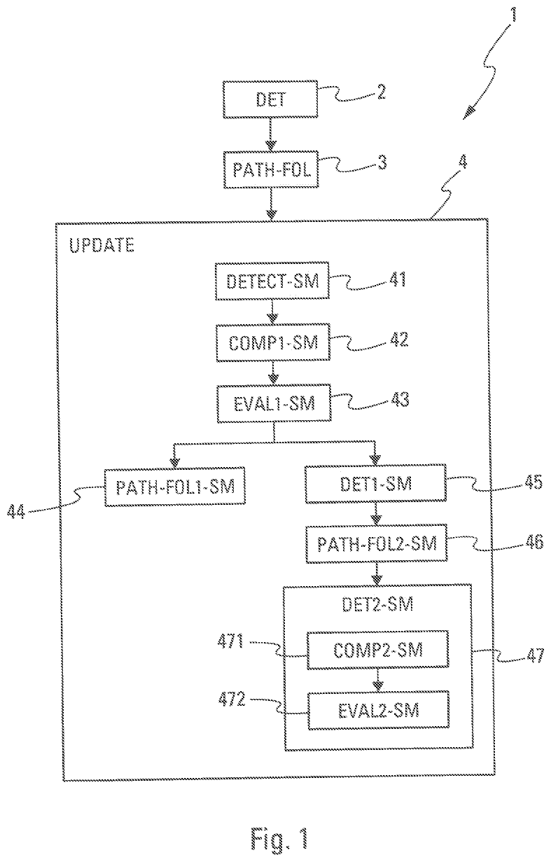

The system 1 for generating and following an optimized flight trajectory of an aircraft AC, called “generation system” hereinafter in the description, is represented in FIG. 1.

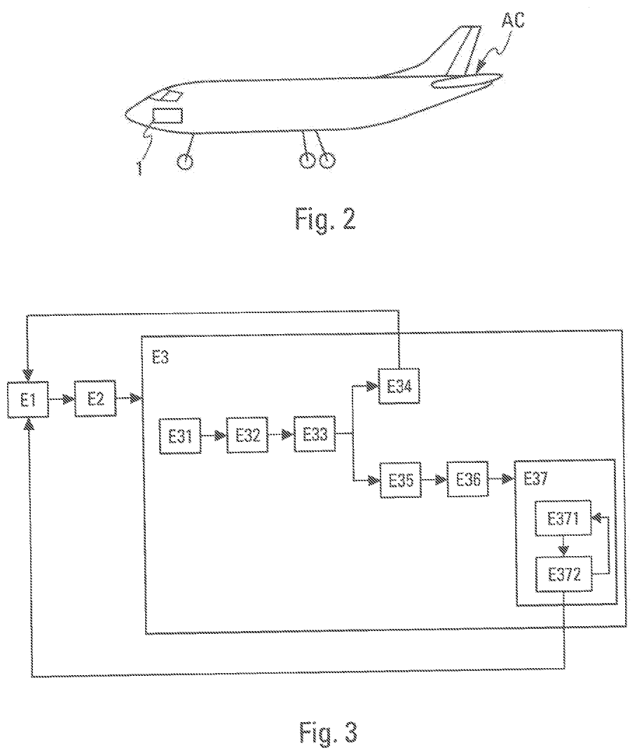

The generation system 1, embedded on the aircraft AC (FIG. 2), comprises a determination module DET (DET for “determination module”) 2, a following module PATH-FOL (PATH-FOL for “path following module”) 3 and an update module UPDATE (UPDATE for “update module”) 4 which are implemented iteratively.

The determination module 2 is configured to determine a long-term flight trajectory from an obstacle prediction model. The long-term flight trajectory is established between a point of departure and a point of arrival, in such a way that the flight trajectory avoids (laterally and/or vertically) all the obstacles which are likely to be encountered between the point of departure and the point of arrival. This long-term trajectory determination can also be called “strategic loop”.

The obstacles can be considered as areas, vector forms such as polygons or risk probability densities.

The determination module 2 can be included in a flight management system FMS.

The obstacle prediction model can correspond to a meteorological prediction model established on the ground and loaded into a memory of the aircraft AC. It can be established several hours before the flight. The obstacle prediction model can be established by an information management device, for example an electronic flight device of EFB device (“Electronic Flight Bag”) type which will have these predictions supplied, for example, by datalinks by internet protocol IP.

According to a first embodiment, the obstacle prediction model is loaded only before the flight.

According to a second embodiment, the obstacle prediction model can be modified during flight and updated by a modification module. The modification module is configured to modify the obstacle prediction model from new meteorological data in the medium and long term sent by a device on the ground.

According to a variant of the second embodiment, the modification module can be a module of the generation system 1, such as a submodule of the determination module 2. According to another variant of the second embodiment, the modification module corresponds to a module of the EFB device which can send the modified obstacle prediction model after the modification module has modified the obstacle prediction model. According to the second embodiment, the long-term flight trajectory is determined by the determination module 2 from the obstacle prediction model which has been modified by the modification module as a function of the new meteorological data transmitted. The new meteorological data can be sent via a datalink to the modification module 5.

The long-term flight trajectory can be determined in several ways. In a nonlimiting manner, the long-term flight trajectory can be determined by:
the minimization of the deviation from the original trajectory by proceeding such that the deviation relative to the initial, obstacle-free route (“cross track” for “route deviation”) is minimal at each point of the trajectory;
the minimization of a total cost function of the flight to the point of arrival;
the minimization of the cost and of the risks;
an adherence to the flight trajectories of preceding aircraft with the aircraft AC circumventing the same obstacles.

Advantageously, the following constraints are taken into account in determining the long-term flight trajectory regardless of the way in which the flight trajectory has been determined:
observance of the predicted performance levels of the aircraft AC at each point of the flight trajectory;
observance of the safety altitudes at all points of the trajectory except for the final approach with a view to landing;
verification of a terrain margin.

The safety altitudes can correspond to an altitude which can be used in emergency conditions such as the altitude MSA (“Minimum Sector Altitude”) or an altitude MORA (“Minimum Off-Route Altitude”).

According to one embodiment, the verification of the terrain margin can be performed by sending, for verification, to a terrain computation model, of the part corresponding to the final approach of the flight trajectory by the determination module 2. The terrain computation module then sends to the determination module 2 a confirmation or a non-confirmation of the validity of the part of the flight trajectory sent.

According to another embodiment, the verification can be performed locally by the determination module 2 using a terrain database stored in a memory possibly included in the generation system 1.

The following module 3 is configured for the aircraft AC to fly by following the long-term flight trajectory determined by the determination module 2.

The update module 4, implemented iteratively, is configured to update the long-term trajectory from a short-term trajectory.

The short-term trajectory is determined as a function of characteristics of at least one obstacle detected during the following of the long-term flight trajectory by the aircraft AC and as a function of a predetermined risk criterion threshold. The short-term flight trajectory is determined to avoid the detected obstacle likely to be encountered by the long-term flight trajectory. This short-term trajectory determination can also be called “tactical loop”.

The tactical loop is implemented independently of the strategic loop.

The update module 4 comprises a detection submodule 41 configured to detect at least one characteristic of at least one obstacle likely to be encountered by the long-term flight trajectory followed by the aircraft AC.

In a nonlimiting manner, the detection submodule DETECT-SM (DETECT-SM for “detection sub-module”) 41, embedded on the aircraft AC, can comprise at least one of the following devices:
weather radar which acquires three-dimensional meteorological matrices from which the vector forms of the obstacles can be determined,
millimetric radar,
laser remote detection (preferably of lidar type, lidar standing for “Laser-Detection And Ranging”),
video sensor,
volcanic ash detector,
hail impact detector.

The update module 4 also comprises a computation submodule COMP1-SM (COMP-SM for “computation sub-module”) 42 configured to compute a criterion of risk of the obstacle or obstacles from the characteristic or characteristics detected by the detection submodule 41 and a risk evaluation submodule EVAL1-SM (EVAL-SM for “evaluation sub-module”) 43 configured to compare the risk criterion with the predetermined risk criterion threshold.

If the risk evaluation submodule 43 evaluates the risk criterion to be below the predetermined risk criterion threshold, the update module 4 is configured to implement:
a following submodule PATH-FOL1-SM 44 configured for the aircraft AC to continue to fly by following the long-term flight trajectory.

According to one embodiment, the submodule 44 corresponds to the following module 3.

If the risk evaluation submodule 43 evaluates the risk criterion to be above or equal to the predetermined risk criterion threshold, the update module 4 is configured to implement:
a determination submodule DET1-SM 45 configured to determine the short-term flight trajectory from the characteristic or characteristics detected by the detection submodule 41;
a following submodule PATH-FOL2-SM 46 configured for the aircraft AC to fly by following the short-term flight trajectory;
a determination submodule DET2-SM 47 configured to determine a new long-term flight trajectory from a state of the aircraft AC corresponding to a final state of the short-term flight trajectory, from the obstacle prediction model and from an evaluation of risks of encountering obstacles.

The state of the aircraft AC corresponds to the heading, to the altitude, to the speed, to the slope, to the vertical speed and to the attitude of the aircraft AC.

Thus, this update module 4 permanently evaluates a solution minimizing the risk criterion and implements a short-term flight trajectory as soon as the risk criterion exceeds the predetermined risk criterion threshold. Contrary to a terrain avoidance, the avoidance based on meteorological data is not binary: it is possible to decide to pass through certain clouds while other clouds, such as clouds containing hail, are to be avoided.

According to one embodiment, the determination submodule 45 is configured to determine the short-term flight trajectory from the obstacle prediction model which is modified by the characteristic or characteristics detected by the detection submodule 41.

The determination submodule 45 is configured to determine the short-term flight trajectory from, in addition, a distance between the aircraft AC and a terrain flown over by the aircraft AC. The distance between the aircraft AC and the terrain flown over can be transmitted to the determination submodule 47 by a terrain proximity computation module in order for the terrain avoidance to take priority over the avoidance of an obstacle.

Moreover, the determination submodule 47 comprises the following submodules, implemented iteratively:
a computation submodule COMP2-SM 471 configured to compute an auxiliary long-term flight trajectory from the final state of the short-term trajectory and from the obstacle prediction model;
a risk evaluation submodule EVAL2-SM 472 configured to evaluate the risk of an obstacle being encountered by the auxiliary long-term flight trajectory.

If the computed auxiliary long-term flight trajectory is likely to cross an obstacle corresponding to an area with risk, the determination submodule 47 reiterates the implementation of the computation submodule 471.

Otherwise, the new long-term flight trajectory corresponds to the auxiliary long-term flight trajectory.

If all the computed long-term flight trajectories are likely to cross an obstacle corresponding to an area with risk, the flight trajectory followed by the aircraft corresponds to a flight trajectory with minimum risk.

The flight trajectory with minimum risk allows the aircraft AC to cross obstacles while proceeding so as to cross them as little as possible and to minimize the impacts. The flight trajectory with minimum risk corresponds to a flight trajectory which will limit to the maximum the passage into areas with risk where the risk criterion exceeds the predetermined risk criterion threshold. Thus, the flight trajectory with minimum risk makes it possible to minimize the overall risk, even if the risk criterion locally exceeds the predetermined risk criterion threshold.

In a nonlimiting manner, the impacts are minimized by performing the following actions:
crossing obstacles windward of the obstacles (the obstacle is located, relative to the aircraft AC, on the side from which the wind is blowing),
climbing,
change of destination if there is a risk of fuel failure,
adaptation of the speed of the aircraft AC,
flying of the aircraft AC with wings flat.

The flight trajectory with minimum risk can be determined by the tactical loop. The minimization of the risk can then be performed by guidance with minimum risk by the tactical loop. Thus, if the strategic loop determines, erroneously, a flight trajectory which involves crossing an obstacle corresponding to a dangerous area, the tactical loop then applies a risk minimization by determining a flight trajectory which circumvents the obstacle totally despite the error in the determination of the flight trajectory by the strategic loop. If the tactical loop does not determine a satisfactory flight trajectory, the aircraft AC can then follow the flight trajectory determined by the strategic loop.

The generation system then makes it possible to limit the complexity, the response times and the need for reliable inputs from the highly integrated tactical loop which guarantees the safety of the aircraft AC. Furthermore, by virtue of the strategic loop, it is possible to incorporate many parameters and to optimize the efficiency of a mission and to minimize the overall risk-taking by retaining a low criticality level relative to the tactical loop which protects the aircraft in case of an error in the determination of a flight trajectory by the strategic loop.

The disclosure herein relates also to a method for generating an optimized flight trajectory of an aircraft AC (FIG. 3).

The generation method comprises the following steps, implemented iteratively:
a determination step E1, implemented by the determination module 2, comprising or consisting in determining a long-term flight trajectory from the obstacle prediction model;
a following step E2, implemented by the following module 3, comprising or consisting in the aircraft AC flying by following the long-term flight trajectory;
an update step E3, implemented iteratively by the update module 4, comprising or consisting in updating the long-term trajectory from a short-term trajectory.

The short-term trajectory is determined as a function of characteristics of at least one obstacle detected during the following of the long-term flight trajectory by the aircraft AC and as a function of the predetermined risk criterion threshold. The short-term flight trajectory is determined to avoid the detected obstacle likely to be encountered by the long-term flight trajectory.

Advantageously, the update step E3 comprises the following substeps:
a detection substep E31, implemented by the detection submodule 41, comprising or consisting in detecting at least one characteristic of at least one obstacle likely to be encountered by the long-term flight trajectory followed by the aircraft AC;
a computation substep E32, implemented by the computation submodule 42, comprising or consisting in computing a criterion of risk of the obstacle or obstacles from the characteristic or characteristics detected in the detection substep E31;
a risk evaluation substep E33, implemented by the risk evaluation submodule 43, comprising or consisting in comparing the risk criterion with the predetermined risk criterion threshold.

If the risk criterion is below the predetermined risk criterion threshold, the update step E3 comprises a following substep E34, implemented by the following submodule 44, comprising or consisting in the aircraft AC continuing to fly by following the long-term flight trajectory.

If the risk criterion is above or equal to the predetermined risk criterion threshold, the update step E3 comprises:
a determination substep E35, implemented by the determination submodule 45, comprising or consisting in determining the short-term flight trajectory from the characteristic or characteristics detected in the detection substep E31;
a following substep E36, implemented by the following submodule 46, comprising or consisting in the aircraft AC flying by following the short-term flight trajectory;
a determination substep E37, implemented by the determination submodule 47, comprising or consisting in determining a new long-term flight trajectory from a state of the aircraft AC corresponding to a final state of the short-term flight trajectory, from the obstacle prediction model and from an evaluation of risks of encountering obstacles.

According to one embodiment, the determination substep E35 comprises determining the short-term flight trajectory from the obstacle prediction model modified by the characteristic or characteristics detected in the detection substep E31.

Moreover, the determination substep E35 comprises determining the short-term flight trajectory from, in addition, a distance between the aircraft AC and a terrain flown over by the aircraft AC.

Furthermore, the determination substep E37 comprises the following substeps, implemented iteratively:
a computation substep E371, implemented by the computation submodule 471, comprising or consisting in computing an auxiliary long-term flight trajectory from the final state of the short-term trajectory and from the obstacle prediction model;
a risk evaluation substep E372, implemented by the risk evaluation submodule 472, comprising or consisting in evaluating the risk of an obstacle being encountered by the auxiliary long-term flight trajectory.

If the computed auxiliary long-term flight trajectory is likely to pass through an area with risk, the determination substep E37 resumes at the computation substep E371. Otherwise, the new long-term flight trajectory corresponds to the auxiliary long-term flight trajectory followed in the following step E2.

Moreover, if all the computed long-term flight trajectories are likely to pass through a zone with risk, the flight trajectory followed by the aircraft AC corresponds to a flight trajectory with minimum risk.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for generating and following an optimized flight trajectory of an aircraft, the method comprising:
a determination step, implemented by a determination module, comprising determining a long-term flight trajectory from an obstacle prediction model;
a following step, implemented by a following module, comprising the aircraft flying by following the long-term flight trajectory;
an update step, implemented iteratively by an update module, comprising updating the long-term trajectory from a short-term trajectory, the short-term trajectory being determined as a function of characteristics of at least one obstacle detected during following of the long-term flight trajectory by the aircraft and as a function of a predetermined risk criterion threshold, the short-term flight trajectory being determined to avoid the detected obstacle likely to be encountered by the long-term flight trajectory.

2. The method according to claim 1, wherein the update step comprises:
a detection substep, implemented by a detection submodule, comprising detecting at least one characteristic of at least one obstacle likely to be encountered by the long-term flight trajectory followed by the aircraft;
a first computation substep, implemented by a first computation submodule, comprising computing a criterion of risk of the obstacle or obstacles from the characteristic or characteristics detected in the detection substep;
a first risk evaluation substep, implemented by a first risk evaluation submodule, comprising comparing the risk criterion with the predetermined risk criterion threshold,
if the risk criterion is below the predetermined risk criterion threshold, the update step comprising:
a first following substep, implemented by a first following submodule, comprising the aircraft continuing to fly by following the long-term flight trajectory;
if the risk criterion is above or equal to the predetermined risk criterion threshold, the update step comprising:
a first determination substep, implemented by a first determination submodule, comprising determining the short-term flight trajectory from the characteristic or characteristics detected in the detection substep;
a second following substep, implemented by a second following submodule, comprising the aircraft flying by following the short-term flight trajectory; and
a second determination substep, implemented by a second determination submodule, comprising determining a new long-term flight trajectory from a state of the aircraft corresponding to a final state of the short-term flight trajectory, from the obstacle prediction model and from an evaluation of risks of encountering obstacles.

3. The method according to claim 2, wherein the first determination substep comprises determining the short-term flight trajectory from the obstacle prediction model modified by the characteristic or characteristics detected in the detection substep.

4. The method according to claim 2, wherein the first determination substep comprises determining the short-term flight trajectory from, in addition, a distance between the aircraft and a terrain flown over by the aircraft.

5. The method according to claim 2, wherein the second determination substep comprises:
a second computation substep, implemented by a second computation submodule, comprising computing an auxiliary long-term flight trajectory from the final state of the short-term trajectory and from the obstacle prediction model;
a second risk evaluation substep, implemented by a second risk evaluation submodule, comprising evaluating the risk of an obstacle being encountered by the auxiliary long-term flight trajectory;
if the computed auxiliary long-term flight trajectory is likely to pass through an area with risk, the second determination substep resumes at the second computation substep,
otherwise, the new long-term flight trajectory corresponds to the auxiliary long-term flight trajectory.

6. The method according to claim 5, wherein, if all the computed long-term flight trajectories are likely to pass through an area with risk, the flight trajectory followed by the aircraft corresponds to a flight trajectory with minimum risk.

7. The method according to claim 1, wherein the long-term flight trajectory is determined in the first determination step, in addition, from meteorological data transmitted to the determination module from a device on the ground.

8. A system for generating and following an optimized flight trajectory of an aircraft, comprising:
a determination module configured to determine a long-term flight trajectory from an obstacle prediction model;
a following module configured for the aircraft to fly by following the long-term flight trajectory;
an update module, implemented iteratively, configured to update the long-term trajectory from a short-term trajectory, the short-term trajectory being determined as a function of characteristics of at least one obstacle detected during following of the long-term flight trajectory by the aircraft and as a function of a predetermined risk criterion threshold, the short-term flight trajectory being determined to avoid the detected obstacle likely to be encountered by the long-term flight trajectory.

9. The system according to claim 8, wherein the update module comprises:
a detection submodule configured to detect at least one characteristic of an obstacle likely to be encountered by the long-term flight trajectory followed by the aircraft;
a first computation submodule configured to compute a criterion of risk of the obstacle or obstacles from the characteristic or characteristics detected by the detection submodule;
a first risk evaluation submodule configured to compare the risk criterion with the predetermined risk criterion threshold,
if the risk criterion is below the predetermined risk criterion threshold, the update module being configured to implement:
a first following submodule configured for the aircraft to continue to fly by following the long-term flight trajectory;
if the risk criterion is above or equal to the predetermined risk criterion threshold, the update module being configured to implement:
a first determination submodule configured to determine the short-term flight trajectory from the characteristic or characteristics detected by the detection submodule;
a second following submodule configured for the aircraft to fly by following the short-term flight trajectory; and
a second determination submodule configured to determine a new long-term flight trajectory from a state of the aircraft corresponding to a final state of the short-term flight trajectory, from the obstacle prediction model and from an evaluation of risks of encountering obstacles.

10. The system according to claim 9, wherein the first determination submodule is configured to determine the short-term flight trajectory from the obstacle prediction model modified by the characteristic or characteristics detected by the detection submodule.

11. The system according to claim 9, wherein the first determination submodule is configured to determine the short-term flight trajectory from, in addition, a distance between the aircraft and a terrain flown over by the aircraft.

12. The system according to claim 9, wherein the second determination submodule comprises:
a second computation submodule configured to compute an auxiliary long-term flight trajectory from the final state of the short-term trajectory and from the obstacle prediction model;
a second risk evaluation submodule configured to evaluate the risk of an obstacle being encountered by the auxiliary long-term flight trajectory;
if the computed auxiliary long-term flight trajectory is likely to pass through an area with risk, the second determination submodule reiterates implementation of the second computation submodule,
otherwise, the new long-term flight trajectory corresponds to the auxiliary long-term flight trajectory.

13. The system according to claim 12, wherein, if all the computed long-term flight trajectories are likely to pass through an area with risk, the flight trajectory followed by the aircraft corresponds to a flight trajectory with minimum risk.

14. An aircraft comprising a system according to claim 8.
